(19) United States
(12) Patent Application Publication
(10) Pub. No.: US 2013/0332644 A1
(43) Pub. Date: Dec. 12, 2013

(54) METHOD OF INITIALIZING A NON-VOLATILE MEMORY SYSTEM

(71) Applicants: Li-Hsiang Chan, Hsinchu City (TW); Kuo-Hung Liao, Hsinchu City (TW)

(72) Inventors: Li-Hsiang Chan, Hsinchu City (TW); Kuo-Hung Liao, Hsinchu City (TW)

(73) Assignee: SKYMEDI CORPORATION, Hsinchu City (TW)

(21) Appl. No.: 13/491,368

(22) Filed: Jun. 7, 2012

(51) Int. Cl. G06F 12/00

(52) U.S. Cl. 711/103; 711/E12.008

(57) ABSTRACT

A method of initializing a non-volatile memory system is disclosed. System data are written to a non-volatile memory based on a formula rule at a factory, and a number of copies of the system data are written to the non-volatile memory. The system data are searched in the non-volatile memory according to the formula rule and a selected data access mode. At least one operating parameter of the selected data access mode is reconfigured, followed by checking if the searched system data are successfully read. The system data are utilized to set the at least one operating parameter of the non-volatile memory system when the searched system data are successfully read from the non-volatile memory.

### BACKGROUND OF THE INVENTION

1. Field of the Invention

The present invention generally relates to a non-volatile memory system, and more particularly to a method of initializing a non-volatile memory system.

2. Description of Related Art

A flash memory is one kind of a non-volatile solid state memory device that can be electrically erased and reprogrammed. The memory capacity of flash memories is improving at an exponential rate as predicted by Moore's law such that the flash memory is propelling into a new generation approximately every 1.5 years. The memory capacity, speed and applications are enhanced owing to improvement in process technology.

The flash memory, however, cannot be 100% flawless. A flash memory ordinarily has some defective (or bad) bits. The faulty flash memories with had bits of a prominent amount may be thrown away, therefore greatly wasting resources.

In the conventional flash memory industry, a flash memory is loaded with a flash ID that describes memory information such as vendor ID, size of a block or a page, process or ECC capability, at the factory by the flash memory makers. However, due to defect bits in the flash memory as discussed above, the loaded flash ID may probably be corrupted, and its associated memory information thus can no longer be recovered later in initializing the flash memory system by a memory controller.

In order to overcome the problems mentioned above, a need has thus arisen to propose a novel scheme of writing system information previously and then reading the system information later in the system initialization.

### SUMMARY OF THE INVENTION

In view of the foregoing, one embodiment of the present invention provides a method of initializing a nonvolatile memory system in a more effective manner such that the non-volatile memories (particularly the faulty non-volatile memories) may be effectively used and system data may be correctly retrieved.

According to one embodiment, a non-volatile memory is provided, into which system data are written previously based on a formula rule. A plurality of copies of the system data are written to the non-volatile memory. The system data are searched in the non-volatile memory according to the formula rule and a selected data access mode in the initialization operation. At least one operating parameter of the selected data access mode is reconfigured. It is checked if the searched system data are successfully read. The system data are utilized to set the at least one operating parameter of the non-volatile memory system when the searched system data are successfully read from the non-volatile memory.

### BRIEF DESCRIPTION OF THE DRAWINGS

FIG. 1 shows a block diagram schematically illustrating a non-volatile memory system according to one embodiment of the present invention;

FIG. 2 shows exemplary pages of the flash memory, among which system data (shaded regions) are located;

FIG. 3 shows memory area (shaded regions) determined by a formula rule, wherein some of the determined memory area may be used to store system data;

FIG. 4 shows a main flow diagram of searching system data in initialization according to one embodiment of the present invention;

FIG. 5 shows a flow diagram illustrating a verification method adaptable to the system data searching associated with one data access mode in the initialization operation performed in FIG. 4;

FIG. 6 shows an example of obtaining a column address (CA) by selecting one or more sectors (or partitions) in a page; and

FIG. 7 shows a flow diagram illustrating a timeout scheme adopted in the embodiment.

### DETAILED DESCRIPTION OF THE INVENTION

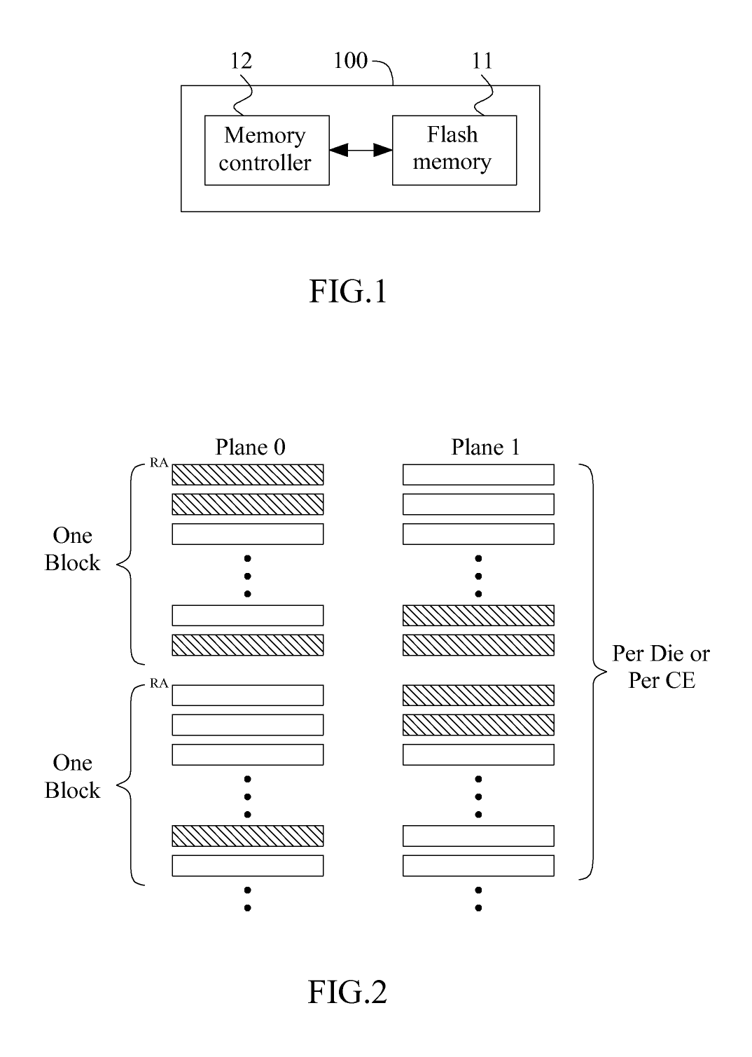

A method of initializing a non-volatile memory system according to one embodiment of the present invention is disclosed. The initialization is a process of preparing a non-volatile memory system 100, as shown in FIG. 1, with a flash memory 11 to be linked to and used by a memory controller 12, which is therefore capable of reading or writing data from/to the flash memory 11 in normal operations. The non-volatile memory of the present invention is not limited by a flash memory, and may include other kinds of non-volatile memory, e.g., a Phase Change Memory, Resistive Random Access Memory, that may have the same problems described above.

The flash memory 11 (e.g., a NAND flash memory) of the embodiment may support, for example, single-level cell (SLC), multi-level cell (MLC) or triple-level cell (TLC) architectures of flash memory. Generally speaking, the embodiment may be adapted to downgraded or normal flash memories. A non-volatile memory system 100 made of, among others, the linked flash memory 11 and the memory controller 12 may be adapted to a storage device such as, but not limited to, solid-state drive (SSD), CompactFlash (CF) Card, CFast Card, MSPro, Secure Digital (SD) Card, uSD Card or Universal Serial Bus (USB) storage.

The embodiment adopts a formula rule, for example, a polynomial equation, based on which memory system data (hereinafter “system data”) are written to the flash memory 11 before initializing the non-volatile memory system 100. In one exemplary embodiment, a polynomial equation 2ⁿ (n is a non-negative integer) is used as the formula rule to determine an address, at which the system data can be stored. According to one aspect of the embodiment, the system data are later retrieved to perform the initialization, rather than retrieving (single) flash memory information, such as flash ID (provided by flash memory makers), which may probably be corrupted and therefore cannot be utilized to finish the initialization. Afterwards, according to the same formula rule, the system data searching performed later in the initialization may become more reliable.

FIG. 2 shows exemplary pages of the flash memory 11, among which the system data (shaded regions) are located. In the specification, a “page” is a basic or fundamental programming unit in the flash memory 11 as conventionally adopted in the flash memory industry. A number of pages form a block, and a page may contain a number of sectors (or partitions). As exemplified in FIG. 2, before initializing the nonvolatile memory system 100, at least one copy of the system data of the embodiment may be written into more than one block, and may even cross between dies or chip enables (CEs). In other words, a copy of the written system data may cross between blocks, pages or sectors in the flash memory 11. Likewise, the system data searching performed later in the initialization may also cross between blocks, pages or sectors (or partitions) in the flash memory 11. Accordingly, the embodiment may capably perform partial partition search in one page, and may capably perform partial page search in one block.

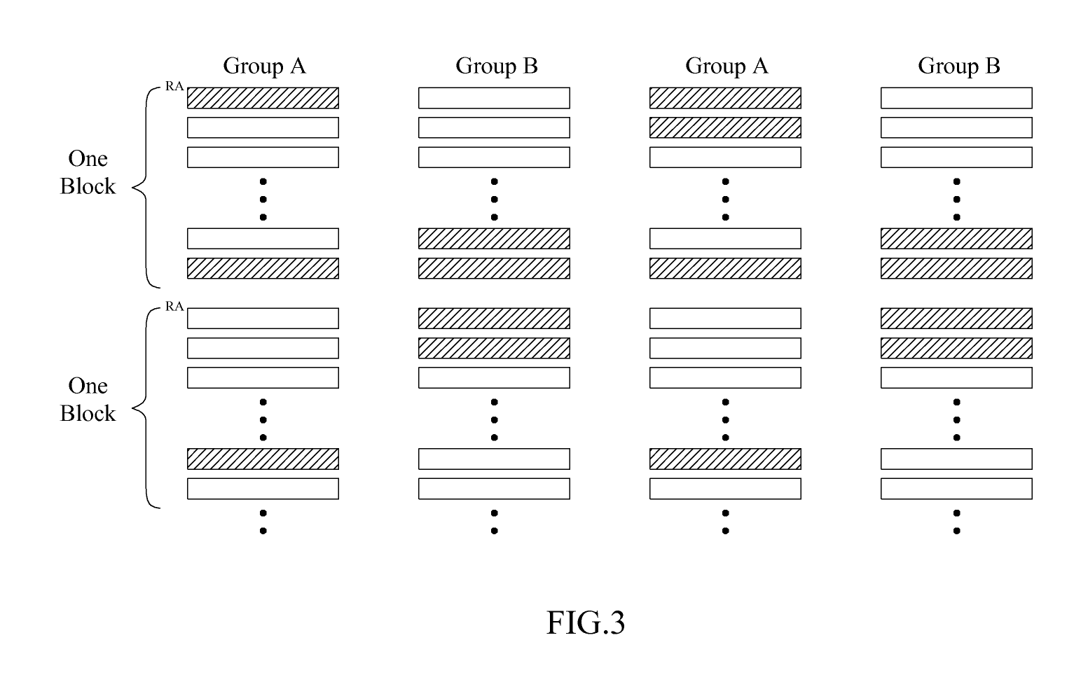

As the flash memory 11 ordinarily has bad bits of an amount that may exceed recovering capability of error correcting code (ECC), a number of copies of the system data are thus written to the flash memory 11, as exemplified in FIG. 3, to ensure success of retrieving the system data later in the initialization. In FIG. 3, shaded regions indicate the memory area determined by the formula rule. In one embodiment, at least some of the memory area (or the shaded regions) determined by the formula rule may be used to store the copies of system data.

Upon successfully searching and retrieving the system data in the initialization, the system data may be utilized to get the appropriate system parameters for the memory controller 12 to control the flash memory 11. According to the appropriate system parameters, the flash memory 11 may then be effectively operated.

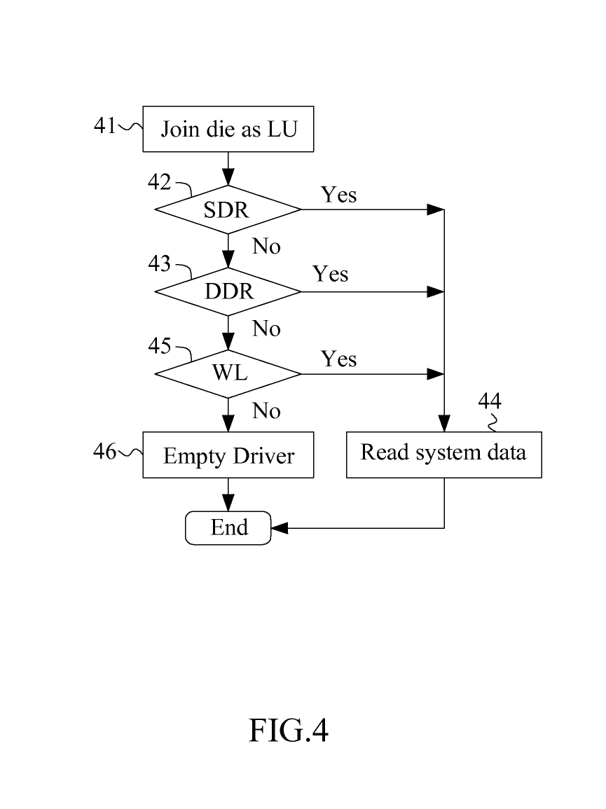

FIG. 4 shows a main flow diagram of searching system data in initialization according to one embodiment of the present invention. In step 41, at least one die is joined to be a searching logic unit (LU). Accordingly, the written system data (that may cross between blocks, pages, sectors or dies) may then be subjected to searching. In step 42, the searched data are assessed to verify a first data access mode (e.g., single data rate (SDR) mode) available for the flash memory 11. If the first data access mode is not positively verified, the searched data are subsequently assessed to verify a second mode (e.g., double data rate (DDR) mode in step 43); otherwise, system data associated with the first data access mode are read from the flash memory 11 (step 44). Similarly, if the second data access mode is not positively verified, the searched data are subsequently assessed to verify a third data access mode (e.g., word line (WL) mode in step 45); otherwise, system data associated with the second data access mode are read from the flash memory 11 (step 44). If the third data access mode is not positively verified, an empty driver (step 46) is returned to an operation system (OS); otherwise, system data associated with the third data access mode are read from the flash memory 11 (step 44).

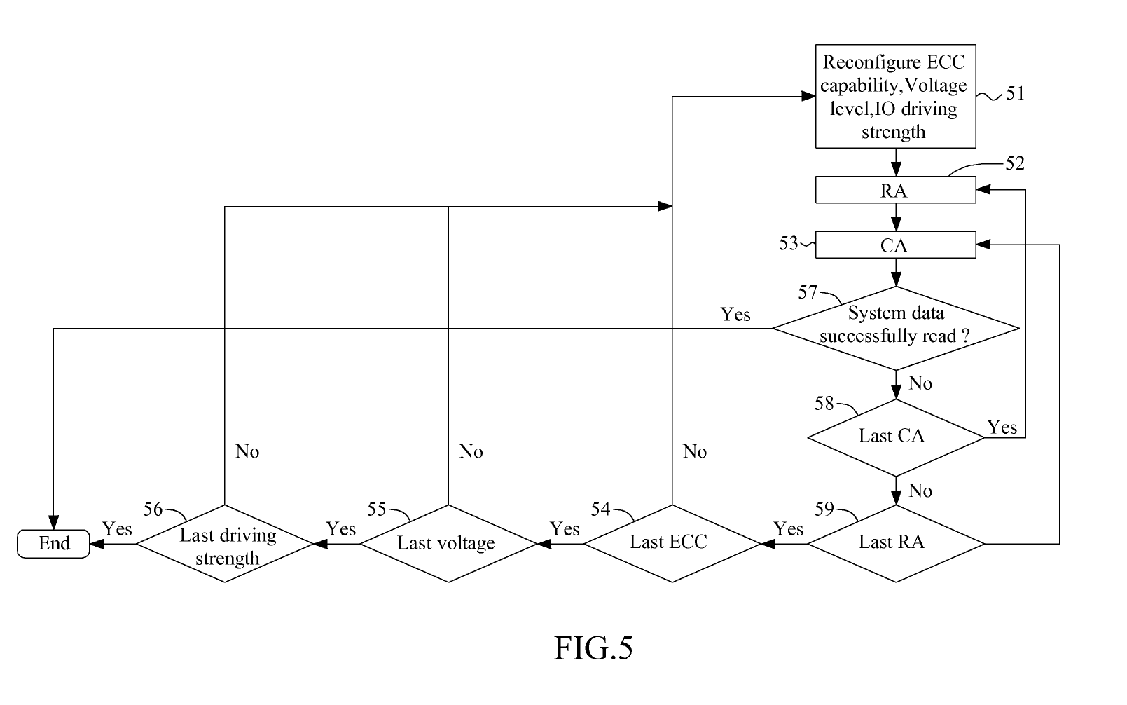

FIG. 5 shows a flow diagram illustrating a verification method adaptable to the system data searching (i.e., step 42, 43 or 45 in FIG. 4) associated with one data access mode in the initialization operation performed in FIG. 4. In the embodiment, the system data contain, among others, ECC capabilities, voltage levels and (input/output) driving strength currents. In step 51, a selected ECC capability, a selected voltage level, and a selected IO driving strength current selected from available operating parameters of the associated data access mode are reconfigured and then checked whether they have acceptable (or optimal) levels for reading data from the flash memory 11.

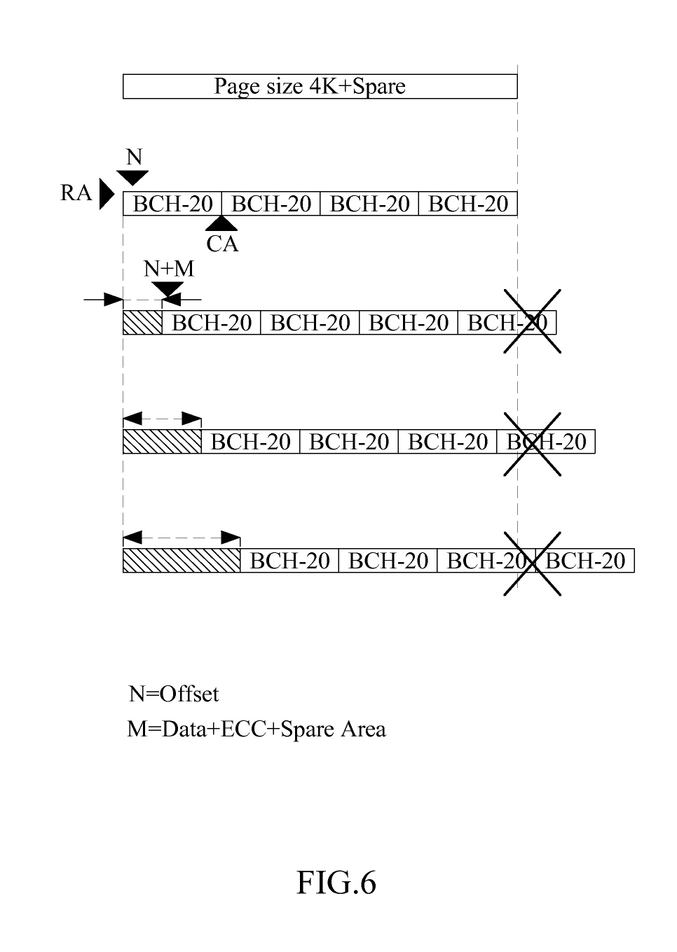

In step 52, the formula rule is used to obtain a row address (RA) of the flash memory 11. In step 53, at least one column address (CA) is obtained by selecting one or more sectors for partitions) in a page as exemplified in FIG. 6. For example, as shown in the figure, the CA may be shifted with an offset N to get away from a bad region (e.g., shaded region).

The steps 51-53 are repeated until all available ECC capabilities, voltage levels and driving strength currents run out (steps 54-56). On the other hand, the flow stops if the searched system data have been successfully read (step 57). If the system data have not been successfully read (step 57) and the last CA has been reached (step 58), the flow goes to step 52 to obtain another RA according to the formula rule; otherwise, the RA is checked (step 59). If the last RA has not been reached, the flow goes to step 53 to obtain another CA. According to the flow shown in FIG. 5, if the searched system data are successfully read, the system data are utilized to set the operating parameters the ICC capability, the voltage level and the driving strength current). On the other hand, if the searched system data are not successfully read, operating parameters of another data access mode (e.g., step 43 or 45) are reconfigured and system data are searched again according to the flow shown in FIG. 5.

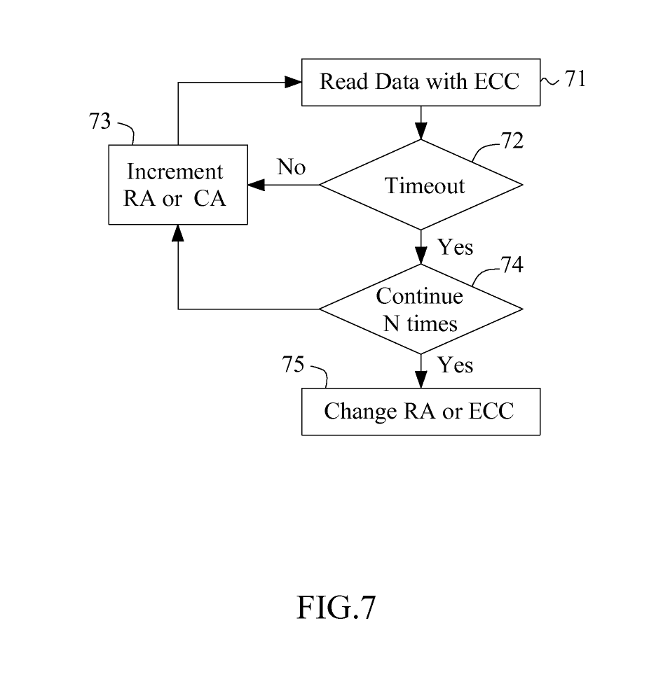

In order to prevent a time lag of unacceptable length while searching the system data, a timeout scheme, as exemplified in FIG. 7, may be adopted in the embodiment. In step 71, data are read with an ECC capability. If a predetermined timeout has not occurred (step 72), RA or CA is incremented (step 73). If the timeout has occurred a predetermined times (step 74), RA or the ECC capability is changed (step 75).

Although specific embodiments have been illustrated and described, it will be appreciated by those skilled in the art that various modifications may be made without departing from the scope of the present invention, which is intended to be limited solely by the appended claims.

What is claimed is:

1. A method of initializing a non-volatile memory system, comprising:
providing a non-volatile memory, into which a plurality of copies of system data are written based on a formula rule;
searching the system data in the non-volatile memory according to the formula rule and a selected data access mode;
reconfiguring at least one operating parameter of the selected data access mode;
checking if the searched system data are successfully read; and
utilizing the system data to set the at least one operating parameter of the non-volatile memory system when the searched system data are successfully read from the non-volatile memory.

2. The method of claim 1, wherein the non-volatile memory is a single-level cell (SLC), multi-level cell (MLC) or triple-level cell (TLC) flash memory.

3. The method of claim 1, wherein the formula rule is a polynomial equation.

4. The method of claim 1, wherein at least some of memory area of the non-volatile memory determined by the formula rule is used to store the plurality of copies of system data.

5. The method of claim 1, wherein the system data cross between blocks, pages or partitions in the non-volatile memory.

6. The method of claim 1, wherein a partial partition search is performed in one page while searching the system data in the non-volatile memory.

7. The method of claim 1, wherein a partial page search is performed in one block while searching the system data in the non-volatile memory.

8. The method of claim 1, wherein the step of reconfiguring at least one operating parameter comprises:
reconfiguring ECC capabilities, voltage levels or IO driving strength currents.

9. The method of claim 1, wherein the selected data access mode is single data rate (SDR), double data rate (DDR) or word line (WL).

10. The method of claim 1, wherein the step of searching the system data comprises:
obtaining a row address (RA) and at least one column address (CA) of the non-volatile memory according to the formula rule.

11. The method of claim 10, wherein another RA is obtained if the system data have not been found and the last CA has been reached.

12. The method of claim 10, wherein the at least one CA is obtained by selecting one or more sectors in a page.

13. The method of claim 10, wherein the RA or the CA is incremented if a predetermined timeout has not occurred.

14. The method of claim 13, wherein the RA is changed if the timeout has occurred a predetermined times.
